(19) United States
(12) Patent Application Publication
(10) Pub. No.: US 2009/0136895 A1
(43) Pub. Date: May 28, 2009

(54) Evacuation Tips having Lateral Vents

(76) Inventor: Ghassan Khalaf, Las Vegas, NV (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 11/946,383

(22) Filed: Nov. 28, 2007

(51) Int. Cl. A61C 17/08

(52) U.S. Cl. 433/91

(57) ABSTRACT

Disclosed is an evacuation tip that is adapted to be used with an evacuation apparatus for collecting the debris and fluids during dental procedures. The evacuation tip comprises a cylindrical body. The evacuation tip has a first end portion and a second end portion. The first end portion comprises at least one vent on a lateral surface of the evacuation tip and a cutout on the first end portion. The at least one vent is configured to suck the oral debris and fluids during the dental procedures. Further, the second end portion is connected to the evacuation apparatus. The evacuation tip is configured to transfer the oral debris and the fluids collected through the at least one vent from the first end portion to the evacuation apparatus connected to the second end portion.

### FIELD OF THE INVENTION

The present invention relates generally to tools used in dentistry, and, more particularly, to apparatuses for evacuating oral debris and fluids during dental procedures.

### BACKGROUND OF THE INVENTION

In the present days, there are numerous types of dental procedures such as dental abrasion to remove tooth fillings, and crowns and caps for shaping teeth structures. These procedures often leave solid oral debris, in addition to fluids (such as blood and saliva) and other waste materials within the mouth of a patient.

There are numerous apparatuses such as evacuation tips and suction mechanism that may be attached with vacuum based suction apparatuses to suck and remove the oral debris and the fluids near the teeth and gums. These apparatuses generally have a mouth piece end having an opening that can suck the debris and the fluids during the dental procedures. In a typical apparatus, the mouth piece end has a flat tube like structure and the opening is configured at an extreme end of the mouthpiece end.

Due to the flat structure and the extreme end positioning of the opening of the mouthpiece end, there is a possibility of these apparatuses irritating the soft tissues surrounding the teeth in the mouth of a patient. Further, these apparatuses have a tendency of sucking the tongue or the soft tissues within the cheek. Furthermore, due to the flat structure, these apparatuses may have a risk of being caught into the neck or the cheek during the dental procedures, in case these apparatuses are dislodged from the hands of dental practitioners.

Based on the foregoing, there is a need for an evacuation tip that is capable of sucking the oral debris and the fluids during dental procedures without irritating the soft tissues within the mouth. Further, the evacuation tip should be comfortable to use during the dental procedures. Furthermore, the evacuation tip should also be capable of eliminating the possibility of sucking the tongue or soft tissues within the cheek during dental procedures.

### SUMMARY OF THE INVENTION

In view of the foregoing disadvantages inherent in the prior art, the general purpose of the present invention is to provide an evacuation tip adapted to be used in dental procedures and configured to include all the advantages of the prior art, and to overcome the drawbacks inherent therein.

Therefore, an object of the present invention is to provide a new and improved evacuation tip for collecting oral debris and fluids during dental procedures.

Another object of the present invention is to provide an evacuation tip that is capable of eliminating the possibility of causing harm to oral tissues in a patient's mouth or sucking the patient's tongue.

It is also an object of the present invention is to provide an evacuation tip that should be disposable and comfortable to use during the dental procedures.

In light of the above objects, in one aspect, the present invention provides an evacuation tip that is adapted to be used with an evacuation apparatus for collecting oral debris and fluids during dental procedures. The evacuation tip has a cylindrical body. The evacuation tip comprises a first end portion and a second end portion. The first end portion comprises at least one vent on a lateral surfaces of the cylindrical body and a cutout on the first end portion. The at least one vent is configured to suck the oral debris and fluids during dental procedures. Further the second end portion is connected to the evacuation apparatus.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1A is a side elevation view of an evacuation tip, according to an exemplary embodiment of the present invention; and

FIG. 1B is a top view of the evacuation tip, according to an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular evacuation tip, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

The present invention provides an evacuation tip that may be used with an evacuation apparatus during dental procedures. The evacuation tip is capable of sucking oral debris and fluids during dental procedures.

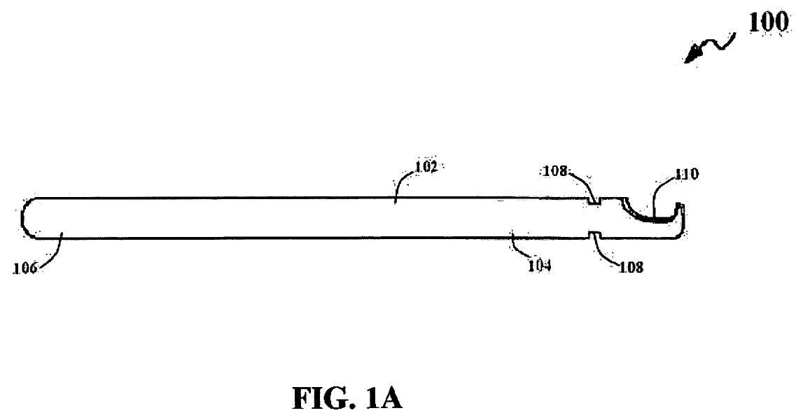

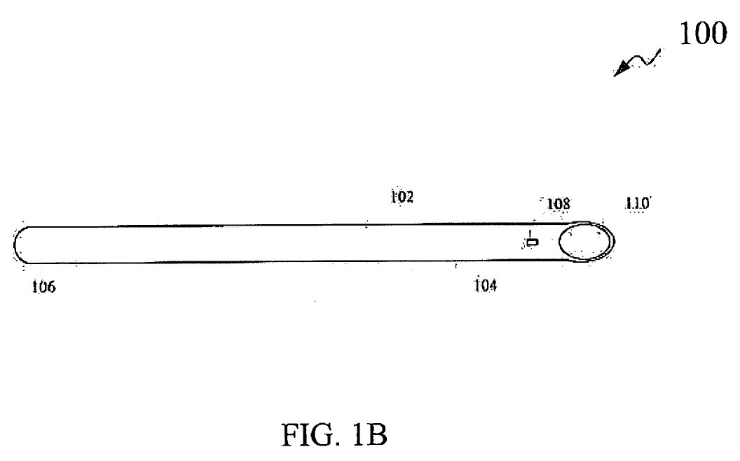

Referring to FIGS. 1A and 1B, an evacuation tip 100 is shown, in accordance with an embodiment of the present invention. FIG. 1A represents a side elevation view of the evacuation tip 100 and FIG. 1B represents a top view of the evacuation tip 100. The evacuation tip 100 is adapted to be used with the evacuation apparatus (not shown) during dental procedures. The evacuation tip 100 is capable of sucking the oral debris and the fluids during the dental procedures. The evacuation tip 100 has a cylindrical body 102. More specifically, the cylindrical body 102 may also be considered as an elongated tubular structure. In an embodiment of the present invention, the cylindrical body 102 is made of plastic materials in order to provide flexibility. However, in other embodiments of the present invention, the cylindrical body 102 may be made of other elastic materials. In an embodiment of the present invention, the cylindrical body 102 may have a diameter of about 10 millimeter (mm) and a length of about 15 centimeter (cm). Further, the cylindrical body 102 may be disposable. These dimensions of the cylindrical body 102 is for exemplary purpose only, however, the cylindrical body 102 may be constructed having varying dimensions based on a required weight of the evacuation tip 100 and preferences of the dental practitioners.

The evacuation tip 100 has a first end portion 104 and a second end portion 106. The first end portion 104 may be considered as a mouthpiece end of the evacuation tip 100, as the first end portion 104 is received at least partially inside the mouth of a patient during the dental procedures. The first end portion 104 has at least one vent such as vents 108 (as shown in FIG. 1A) and a cutout 110. The two vents 108 are shown for exemplary representation of the evacuation tip 100 only and it should not be considered limiting. The vents 108 are configured on the cylindrical body 102 of the evacuation tip 100. More specifically, the vents 108 are formed on a lateral surface of the cylindrical body 102. The vents 108 are configured to suck objects including, but not limited to, oral debris and fluids during the dental procedures. After sucking, the vents 108 pass the collected objects through a plurality of passages (not shown) to the second end portion 106. These passages may be fins or tubes having smaller diameters and configured within the cylindrical body 102 between the first end portion 104 and the second end portion 106.

In one embodiment of the present invention, the cutout 110 is formed in a corner of the first end portion 104, as shown in FIGS. 1A and 1B. The cutout 110 may be configured such that it has a round arc shape in the corner of the first end portion 104. However, in other embodiments of present invention, the cutout 110 may also have shapes other than the round arc shape. The cutout 110 facilitates the evacuation tip 100 to rest against the teeth or the tongue during the dental procedures in order to avoid the possibility of getting the evacuation tip 100 caught in the cheek or the tongue during the dental procedures.

The second end portion 106 is connected to the evacuation apparatus. The evacuation apparatus may be a vacuum pump for example, which is configured to generate suction force. As the evacuation apparatus is connected to the evacuation tip 100 at the second portion 106, the suction force is also applied at the vents 108 through the plurality of internal passages. Therefore, the suction force at the vents 108 facilitates collection of the oral debris and fluids through the vents 108 during the dental procedures.

Based on the above discussions, it will be apparent to a person skilled in the art that due to the positioning of the vents 108 on the lateral surface of the evacuation tip 100, and the cutout 110 that is round in its dimensions, the evacuation tip 100 does not tend to irritate the soft tissues within the patient's mouth. The possibility of the evacuation tip 100 of getting caught in the cheek or the tongue during the dental procedures may be eliminated. Further, due to the positioning of the vents 108 on the lateral surface, the possibility of sucking of the tongue and the cheek is eliminated. Furthermore, the evacuation tip 100 is disposable and more comfortable than the conventional flat tip evacuation tips and is easy to use.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. An evacuation tip adapted to be used with an evacuation apparatus during dental procedures, the evacuation tip comprising a cylindrical body having a first end portion and a second end portion,
wherein the first end portion comprises at least one vent configured on a lateral surface of the cylindrical body and a cutout configured on the first end portion, the at least one vent configured to suck oral debris and fluids during the dental procedures, and
wherein the second end portion of the cylindrical body is connected to the evacuation apparatus.

2. The evacuation tip of claim 1, wherein the cylindrical body has a diameter of about 10 millimeter (mm) and length of about 15 centimeter (cm).

3. The evacuation tip of claim 1, wherein the evacuation tip is composed of disposable plastic material.

4. The evacuation tip of claim 1, further comprising a plurality of passages configured within the cylindrical body, the plurality of passages connecting the first end portion and the second end portion and configured to transfer the oral debris and the fluids collected through the at least one vent from the first end portion to the evacuation apparatus connected to the second end portion.
